(19) United States
(12) Patent Application Publication
(10) Pub. No.: US 2013/0332268 A1
(43) Pub. Date: Dec. 12, 2013

(54) SELECTIVE CUSTOMER INTERACTIONS OVER A COMPUTER NETWORK

(71) Applicant: John C. Foster, Newport Coast, CA (US)

(72) Inventor: John C. Foster, Newport Coast, CA (US)

(21) Appl. No.: 13/910,047

(22) Filed: Jun. 4, 2013

Related U.S. Application Data
(60) Provisional application No. 61/655,996, filed on Jun. 5, 2012.
(60) Provisional application No. 61/656,510, filed on Jun. 6, 2012.

(51) Int. Cl. G06Q 30/02

(52) U.S. Cl. CPC G06Q 30/0248
USPC 705/14.47

(57) ABSTRACT

Methods for selling items over a computer network can include: after a first set of customers has purchased, during a first time period, at least a threshold value or number of items of a first set of items: (a) during a second time period after the first period, offering for sale to the first set of customers an index set of items; (b) throughout the second period, preventing substantially all persons other than the first set of customers from purchasing the index set of items; and (c) during a third time period, offering for sale to a second set of customers, different from the first set of customers, any of the index set of items not sold to the first set of customers during the second period.

### RELATED APPLICATIONS

This application claims priority benefit from U.S. Provisional Application No. 61/655,996, filed Jun. 5, 2012, and U.S. Provisional Application No. 61/656,510, filed Jun. 6, 2012, the entire contents of each of which are incorporated herein by reference.

### FIELD

The subject technology relates to relates to computer-implemented systems that enable transactions between customers and merchants through a communications network, such as the Internet.

### BACKGROUND

A variety of types of network-based electronic commerce systems exist, including for sales or auctions. A number of these implement the traditional English auction. This mechanism efficiently allocates individual lots by awarding them to the buyers who attribute the most value to them. English auctions are not necessarily an optimum mechanism for selling larger quantities of goods, such as seasonal retail items, overstock, or discontinued merchandise, and these types of goods are therefore often sold using other types of electronic sales systems.

Some of these alternate systems strive to reproduce an in-store shopping experience in which goods are offered for sale at a particular non-negotiable markdown price. This approach requires sellers to gauge the demand for their products so that they can determine a price that is high enough to allow them an acceptable return, but not so high that few or no buyers will purchase them. This process can be difficult and time consuming, and may be too much so to be warranted for relatively small lots of goods. And setting a particular price can also allow some individuals who place a high value on an item to buy it for less than that value.

To enable convenient purchases of goods and services by consumers, the financial service industry has developed many alternative payment methods, including checks, ATM or debit cards, credit cards or charge cards. Until the birth of virtual commerce, as discussed below, these payment options provided adequate convenience and transactional security to consumers and merchants in the marketplace.

Virtual commerce and the growth of the Internet as a medium for commerce has put pressure on both convenience and transactional security. Specifically, checks require physical presentment and clearing of the check prior to shipment of goods. Credit cards are more convenient for the consumer, but are subject to fraudulent use via theft of the account number, expiration date and address of the consumer. Debit cards lack a credit facility and often require a separate personal identification number (PIN) number to be used. The financial services industry attempts to improve performance of existing products by using disposable account numbers and electronic checks. The improvements offered have sought to improve transactional security at the expense of the convenience during the purchase process.

Payment options in place today have significant shortcomings when applied to remote purchases. Remote purchases are defined as those purchases where the buyer and the seller (the merchant) are not physically proximate during the transaction. Specific examples of remote purchases are mail order, telephone order, Internet and wireless purchases.

Merchants have long battled the problem of fraudulent purchases. New payment options and new sales channels (in-store, telephone, mail, and Internet) have spawned innovation on the part of consumers willing to perpetrate fraud to obtain goods and services without paying for them. The Internet commerce industry and the continued growth in mail order and telephone order commerce has pushed the credit card to the forefront of these battles. Merchants are forced to rely on credit cards because it is currently their main option in the remote purchase environment. Credit cards offer low transactional security to both merchants and consumers when used for remote purchases.

### SUMMARY

The subject technology is illustrated, for example, according to various aspects described below. Various examples of aspects of the subject technology are described as numbered clauses (1, 2, 3, etc.) for convenience. These are provided as examples and do not limit the subject technology. It is noted that any of the dependent clauses may be combined in any combination, and placed into a respective independent clause, e.g., clause 1 or clause 55. The other clauses can be presented in a similar manner.

1. A method of selling items over a computer network, comprising:

after each customer of a first set of one or more customers has been selected by a set of one or more sellers during a first time period;

from a first set of one or more computers at a network and during a second time period after the first period, offering for sale, by the set of sellers and to the first set of customers, an index set of one or more items, each item of the index set of items offered at a respective first price for a respective first quantity of the item;

throughout the second period and by at least one processor, preventing substantially all persons other than the first set of customers from purchasing any of the index set of items, at the respective first price for the respective first quantity, from the set of sellers over the network; and

over the network and during a third time period after the second period, offering for sale to a second set of one or more customers, different from the first set of customers, any item of the index set of items not sold to the first set of customers during the second period.

2. The method of claim 1, wherein the first set of customers has been selected by the set of sellers, during the first period, based on at least one of (a) a threshold value of one or more items of a first set of one or more items purchased by the first set of customers from the set of sellers, or (b) a threshold number of the one or more items of the first set of items, wherein the threshold value and the threshold number are each greater than zero.

3. The method of claim 1, further comprising, throughout the second period, preventing substantially all persons other than the first set of customers from purchasing any of the index set of items from the set of sellers over the network.

4. The method of claim 1, further comprising, throughout the second period, preventing substantially all persons other than the first set of customers from purchasing any of the index set of items from any seller over the network.

5. The method of claim 1, wherein the at least one of the threshold value or the threshold number is determined by the set of sellers.

6. The method of claim 1, wherein the second set of customers comprises the public.

7. The method of claim 1, wherein the second set of customers includes the first set of customers.

8. The method of claim 1, wherein the first set of computers comprises a server computer, and each customer of the first set of customers has purchased the one or more items of the first set of items, during the first period, at a respective remote computer in the network.

9. The method of claim 1, wherein the second period comprises at least one day.

10. The method of claim 1, wherein the computer network comprises the Internet.

11. The method of claim 1, further comprising, after at least one item of the index set of items has been purchased during the third period by at least one of the second set of customers, preventing substantially all of the first set of customers from purchasing, during the third period, the at least one item of the index set of items.

12. The method of claim 1, further comprising, throughout the second period, preventing all persons other than the first set of customers from purchasing any of the index set of items over the network.

13. The method of claim 1, further comprising, during the third period, offering for sale to the second set of customers all items of the index set of items not sold to the first set of customers.

14. The method of claim 1, further comprising, during the third period, offering for sale to the first set of customers the any item of the index set of items not sold to the first set of customers during the second period.

15. The method of claim 1, further comprising, during the third period, offering for sale, at substantially the respective first price for the respective first quantity, to the first set of customers the any item of the index set of items not sold to the first set of customers during the second period.

16. The method of claim 1, wherein:

during the third period, each item of the any of the index set of items not sold to the first set of customers is offered for sale, by the set of sellers and to the second set of customers, at a respective second price for a respective second quantity of the item;

wherein, for each item of the any of the index set of items, the multiplication product of the respective first price and the respective first quantity is less than the multiplication product of the respective second price and the respective second quantity.

17. The method of claim 1, wherein the respective first price of a first item of the index set of items (a) differs, as offered by the set of sellers, among customers of the first set of customers, and (b) is based on a respective score determined by a processor and associated with each of at least one customer of the first set of customers.

18. The method of claim 1, wherein the respective first price of a first item, of the index set of items, offered during the second period by a first seller of the set of sellers, to a first customer of the first set of customers, is lower in (a) the event the selection of the first customer during the first period is by the first seller, than in (b) the event the selection of the first customer during the first period is by a second seller of the set of sellers.

19. The method of claim 18, wherein, upon occurrence of the event (b), the first seller pays a portion of the respective first price to the second seller.

20. The method of claim 17, wherein the score associated with a respective customer is displayed at the network to the respective customer.

21. The method of claim 17, wherein the score associated with a respective customer is based on one or more factors selected from the group of factors consisting of:

(a) a number of items purchased by the respective customer from the set of sellers;

(b) a frequency of purchases made by the respective customer from the set of sellers;

(c) an amount paid for one or more purchases by the respective customer;

(d) whether the respective customer returned an item sold by the set of sellers;

(e) whether a return to the set of sellers of an item was determined by the set of sellers to have been made in good faith by the respective customer;

(f) whether the respective customer was determined to have engaged in a fraudulent transaction;

(g) whether the respective customer recommended, over a computer network, to another entity an item offered for sale by the set of sellers; and

(h) whether the respective customer provided, over the network, feedback regarding an item offered for sale by the set of sellers.

22. The method of claim 21, wherein the score associated with the respective customer is based on two or more factors selected from the group of factors.

23. The method of claim 21, wherein the score associated with the respective customer is based on three or more factors selected from the group of factors.

24. The method of claim 21, wherein the score associated with the respective customer is based on four or more factors selected from the group of factors.

25. The method of claim 21, wherein the score associated with the respective customer is based on five or more factors selected from the group of factors.

26. The method of claim 21, further comprising displaying the score to the respective customer at the network.

27. The method of claim 1, wherein:

during the second period, each item of the index set of items is offered for sale, by the set of sellers and to the first set of customers, from a first network site;

during the third period, each item of the any of the index set of items is offered for sale, by the set of sellers and to the second set of customers, from a second network site, different from the first network site.

28. The method of claim 27, wherein each of the first and second network sites comprises an Internet website.

29. The method of claim 27, wherein each of the first and second network sites comprises a different area of the same Internet website.

30. The method of claim 27, wherein, during the first period, each of the first set of customers has purchased the one or more items of the first set of items from the second network site.

31. The method of claim 1, further comprising:

before the second time period, receiving, from a remote computer and into a data storage, data representing (a) identification of the set of sellers and (b) the index set of items;

during the second time period and by a processor, displaying to the first set of customers an indicator of a first portion of the data, the first portion representing the index set of items for sale to the first set of customers; and

during the third time period, displaying to the second set of customers an indicator of a second portion of the data, the second portion representing the any of the index set of items not sold to the first set of customers.

32. The method of claim 31, wherein the displaying to the second set of customers during the third time period occurs without further input from the set of sellers occurring after the receiving.

33. The method of claim 31, further comprising:

throughout the second period and by a processor, substantially preventing display to persons, at remote computers on the network, other than the first set of customers the indicator of the first portion.

34. A method of selling items over a computer network, comprising:

after each customer of a first set of one or more customers has purchased, over a computer network and from a seller during a first time period, at least one of (a) a threshold value of one or more items of a first set of one or more items, or (b) a threshold number of the one or more items, wherein the threshold value and the threshold number are each greater than zero;

from a first set of one or more computers at the network and during a second time period after the first period, offering for sale, by the seller and to the first set of customers, an index set of one or more items, each item of the index set of items offered at a respective first price for a respective first quantity of the item;

throughout the second period and by at least one processor, preventing substantially all persons other than the first set of customers from purchasing any of the index set of items, at the respective first price for the respective first quantity, from the seller over the network; and

over the network and during a third time period after the second period, offering for sale to a second set of one or more customers, different from the first set of customers, any item of the index set of items not sold to the first set of customers during the second period.

35. A machine-readable medium encoded with instructions for selling items over a computer network, the instructions comprising code for performing the following method:

after each customer of a first set of one or more customers has purchased, over a computer network and from a seller during a first time period, at least one of (a) a threshold value of one or more items of a first set of one or more items, or (b) a threshold number of the one or more items, wherein the threshold value and the threshold number are each greater than zero;

from a first set of one or more computers at the network and during a second time period after the first period, offering for sale, by the seller and to the first set of customers, an index set of one or more items, each item of the index set of items offered at a respective first price for a respective first quantity of the item;

throughout the second period and by at least one processor, preventing substantially all persons other than the first set of customers from purchasing any of the index set of items, at the respective first price for the respective first quantity, from the seller over the network; and

over the network and during a third time period after the second period, offering for sale to a second set of one or more customers, different from the first set of customers, any item of the index set of items not sold to the first set of customers during the second period.

36. A processor-based system for selling items over a computer network, comprising:

an offering module that (i) after confirmation is received by the system that each customer of a first set of one or more customers has purchased, over a computer network and from a seller during a first time period, at least one of (a) a threshold value of one or more items of a first set of one or more items, or (b) a threshold number of the one or more items, wherein the threshold value and the threshold number are each greater than zero, and (ii) from a first set of one or more computers at the network and during a second time period after the first period, offers for sale, by the seller and to the first set of customers, an index set of one or more items, each item of the index set of items offered at a respective first price for a respective first quantity of the item;

a preventing module that, throughout the second period and by at least one processor, prevents substantially all persons other than the first set of customers from purchasing any of the index set of items, at the respective first price for the respective first quantity, from the seller over the network; and

wherein the offering module, over the network and during a third time period after the second period, offers for sale to a second set of one or more customers, different from the first set of customers, any item of the index set of items not sold to the first set of customers during the second period.

37. A processor-based system for selling items over a computer network, comprising:

a set of one or more modules, the set programmed with instructions, executable by a processor, to perform the following method:

after each customer of a first set of one or more customers has purchased, over a computer network and from a seller during a first time period, at least one of (a) a threshold value of one or more items of a first set of one or more items, or (b) a threshold number of the one or more items, wherein the threshold value and the threshold number are each greater than zero;

from a first set of one or more computers at the network and during a second time period after the first period, offering for sale, by the seller and to the first set of customers, an index set of one or more items, each item of the index set of items offered at a respective first price for a respective first quantity of the item;

throughout the second period and by at least one processor, preventing substantially all persons other than the first set of customers from purchasing any of the index set of items, at the respective first price for the respective first quantity, from the seller over the network; and

over the network and during a third time period after the second period, offering for sale to a second set of one or more customers, different from the first set of customers, any item of the index set of items not sold to the first set of customers during the second period.

38. The system of claim 1, further comprising, throughout the second period, preventing substantially all persons other than the first set of customers from purchasing any of the index set of items from the seller over the network.

39. The system of claim 1, further comprising, throughout the second period, preventing substantially all persons other than the first set of customers from purchasing any of the index set of items from any seller over the network.

40. The system of claim 1, wherein the at least one of the threshold value or the threshold number is determined by the seller.

41. The system of claim 1, wherein the second set of customers comprises the public.

42. The system of claim 1, wherein the second set of customers includes the first set of customers.

43. The system of claim 1, wherein the first set of computers comprises a server computer, and each customer of the first set of customers has purchased the one or more items of the first set of items, during the first period, at a respective remote computer in the network.

44. The system of claim 1, wherein the second period comprises at least one day.

45. The system of claim 1, wherein the computer network comprises the Internet.

46. The system of claim 1, further comprising, after at least one item of the index set of items has been purchased during the third period by at least one of the second set of customers, preventing substantially all of the first set of customers from purchasing, during the third period, the at least one item of the index set of items.

47. The system of claim 1, further comprising, throughout the second period, preventing all persons other than the first set of customers from purchasing any of the index set of items over the network.

48. The system of claim 1, further comprising, during the third period, offering for sale to the second set of customers all items of the index set of items not sold to the first set of customers.

49. The system of claim 1, further comprising, during the third period, offering for sale to the first set of customers the any item of the index set of items not sold to the first set of customers during the second period.

50. The system of claim 1, further comprising, during the third period, offering for sale, at substantially the respective first price for the respective first quantity, to the first set of customers the any item of the index set of items not sold to the first set of customers during the second period.

51. The system of claim 1, wherein:

during the third period, each item of the any of the index set of items not sold to the first set of customers is offered for sale, by the seller and to the second set of customers, at a respective second price for a respective second quantity of the item;

wherein, for each item of the any of the index set of items, the multiplication product of the respective first price and the respective first quantity is less than the multiplication product of the respective second price and the respective second quantity.

52. The system of claim 1, wherein the respective first price of a first item of the index set of items (a) differs, as offered by the seller and displayed at the network, among customers of the first set of customers, and (b) is based on a respective score determined by a processor and associated with each of at least one customer of the first set of customers.

53. The system of claim 17, wherein the score associated with a respective customer is based on one or more factors selected from the group of factors consisting of:

(a) a number of items purchased by the respective customer from the seller;

(b) a frequency of purchases made by the respective customer from the seller;

(c) an amount paid for one or more purchases by the respective customer;

(d) whether the respective customer returned an item sold by the seller;

(e) whether a return to the seller of an item was determined by the seller to have been made in good faith by the respective customer;

(f) whether the respective customer was determined to have engaged in a fraudulent transaction;

(g) whether the respective customer recommended, over a computer network, to another entity an item offered for sale by the seller; and

(h) whether the respective customer provided, over the network, feedback regarding an item offered for sale by the seller.

54. The system of claim 21, wherein the score associated with the respective customer is based on two or more factors selected from the group of factors.

55. The system of claim 21, wherein the score associated with the respective customer is based on three or more factors selected from the group of factors.

56. The system of claim 21, wherein the score associated with the respective customer is based on four or more factors selected from the group of factors.

57. The system of claim 21, wherein the score associated with the respective customer is based on five or more factors selected from the group of factors.

58. The system of claim 21, further comprising displaying the score to the respective customer at the network.

59. The system of claim 1, wherein:

during the second period, each item of the index set of items is offered for sale, by the seller and to the first set of customers, from a first network site;

during the third period, each item of the any of the index set of items is offered for sale, by the seller and to the second set of customers, from a second network site, different from the first network site.

60. The system of claim 27, wherein each of the first and second network sites comprises an Internet website.

61. The system of claim 27, wherein each of the first and second network sites comprises a different area of the same Internet website.

62. The system of claim 27, wherein, during the first period, each of the first set of customers has purchased the one or more items of the first set of items from the second network site.

63. The system of claim 1, further comprising:

before the second time period, receiving, from a remote computer and into a data storage, data representing (a) identification of the seller and (b) the index set of items;

during the second time period and by a processor, displaying to the first set of customers an indicator of a first portion of the data, the first portion representing the index set of items for sale to the first set of customers; and

during the third time period, displaying to the second set of customers an indicator of a second portion of the data, the second portion representing the any of the index set of items not sold to the first set of customers.

64. The system of claim 31, wherein the displaying to the second set of customers during the third time period occurs without further input from the seller occurring after the receiving.

65. The system of claim 31, further comprising:

throughout the second period and by a processor, substantially preventing display to persons, at remote computers on the network, other than the first set of customers the indicator of the first portion.

66. A method of selling items over a computer network, comprising:

by a processor, determining respective scores for customers, the score for each customer based on characteristics of the customer's past purchases from a seller; and

offering items for sale, over a computer network, to the customers at prices based on the respective scores.

67. A processor-based system for selling items over a computer network, comprising:

a scoring module that determines respective scores for customers, the score for each customer based on characteristics of the customer's past purchases from a seller; and

an offering module that offers items for sale, over a computer network, to the customers at prices based on the respective scores.

68. A method of selling items over a computer network, comprising:

after each of a first set of one or more customers has, during a first time period, met at least one criterion of a first group of criteria concerning a first set of one or more items;

over a computer network and during a second time period after the first period, offering for sale, by a seller and to the first set of customers, an index set of one or more items;

wherein the first group of criteria consists of:

a customer having purchased, over the network, at least one of a threshold value of items, or a threshold number of items, of the first set of items during the first period, wherein the threshold value and the threshold number are each greater than zero;

throughout the second period, preventing substantially all persons other than the first set of customers from purchasing any of the index set of items over the network; and

over the network and during a third time period after the second period, offering for sale to a second set of one or more customers, different from the first set of customers, any of the index set of items that was not sold to the first set of customers.

69. A method of selling items via a computer network, comprising:

(a) selling any of a first plurality of items to each of a first plurality of customers via a first website, wherein each of the first plurality of customers purchases an item of the first plurality;

(b) after (a), offering a second plurality of items for sale via a second website;

(c) permitting only the first plurality of customers to purchase items of the second plurality of items via the second website;

(e) during (c) and after at least one item of the second plurality is purchased by at least one of the first plurality of customers, offering other of the items of the second plurality for sale via the first website to a second plurality of customers.

70. A method of selling items via a computer network, comprising:

(a) selling a first plurality of items to a first plurality of customers at a first computer network site, such that each of the first plurality of customers purchases an item of the first plurality;

(b) after (a), permitting the first plurality of customers to purchase any of a second plurality of items at a second computer network site;

(c) preventing persons other than the first plurality of customers from purchasing any of the second plurality of items at the second site;

(d) during (c) and after at least one of the second plurality of items is purchased by at least one of the first plurality of customers, offering other of the second plurality of items for sale at the first site to a second plurality of customers.

71. The method of claim 70, wherein the second plurality of customers includes at least one of the first plurality of customers.

72. The method of claim 70, wherein the first and second sites comprise websites.

73. A method of selling items via a computer network, comprising:

(a) selling a first plurality of items to a first plurality of customers at a first computer network area, such that each of the first plurality of customers purchases an item of the first plurality;

(b) after (a), permitting the first plurality of customers to purchase any of a second plurality of items at a second computer network area;

(c) preventing persons other than the first plurality of customers from purchasing any of the second plurality of items at the second area;

(d) during (c) and after at least one of the second plurality of items is purchased by at least one of the first plurality of customers, offering other of the second plurality of items for sale at the first area to a second plurality of customers.

74. The method of claim 73, wherein none of the other of the second plurality of items is purchased by any of the first plurality of customers at the second area before the offering of the other of the second plurality of items at the first area.

75. The method of claim 73, wherein the second plurality of customers includes at least one of the first plurality of customers.

76. The method of claim 73, wherein the first and second areas comprise different websites.

77. The method of claim 73, wherein the first and second areas comprise different areas of the same website.

78. The method of claim 73, wherein the first and second areas comprise different pages of the same website.

79. A method of selling items via the Internet, comprising:

(a) selling a first plurality of items to a first plurality of customers at a first website, such that each of the first plurality of customers purchases an item of the first plurality from a seller during a first time period;

(b) during a second time period after the first period, permitting the first plurality of customers to purchase any of a second plurality of items at a second website;

(c) during the second period, preventing persons other than the first plurality of customers from purchasing any of the second plurality of items at the second website; and

(d) during a third time period after the second period, and after at least one of the second plurality of items has been purchased by at least one of the first plurality of customers, offering all but the at least one of the second plurality of items for sale at the first website to a second plurality of customers.

80. The method of claim 79, further comprising preventing substantially all persons except the first plurality of customers from purchasing any of the second plurality of items at the second website during the second period.

81. The method of claim 79, wherein the first website is accessible to the first plurality of customers through a first domain name, and the second website is accessible to the first plurality of customers through a second domain name.

82. The method of claim 79, further comprising preventing the first plurality of customers from purchasing any of the second plurality of items at the second area during the third period.

83. The method of claim 79, wherein the second plurality of customers includes at least one of the first plurality of customers.

84. The method of claim 79, wherein the first and second areas comprise different websites.

85. The method of claim 79, wherein the first and second areas comprise different areas of the same website.

86. The method of claim 79, wherein the first and second areas comprise different pages of the same website.

87. The method of claim 79, further comprising preventing substantially all persons except the first plurality of customers from accessing the second area during the second period.

88. The method of claim 79, further comprising preventing substantially all persons from purchasing any of the second plurality of items at the second area during the third time period.

89. The method of claim 79, further comprising, during or before the second period, notifying the first plurality of customers of at least one of a duration of the second period and an end time of the second period.

90. The method of claim 79, wherein, during the second period, each of the second plurality of items is offered for sale to the first plurality of customers at the second area at a respective first price, and wherein each of the all but the at least one of the second plurality of items is offered for sale at the first area during the third period to the second plurality of customers at a respective second price, higher than the first price for that item.

91. The method of claim 79, further comprising requiring each of the first plurality of customers to purchase more than one of the first plurality of items during the first time period before the first plurality of customers is permitted to purchase any of the second plurality of items at the second area.

92. The method of claim 91, further comprising permitting the seller to determine a number of the first plurality of items that each of the first plurality of customers is required to purchase during the first time period before the first plurality of customers is permitted to purchase any of the second plurality of items at the second area.

93. The method of claim 79, wherein the seller performs the offering of the all but the at least one of the second plurality of items at the first area to the second plurality of customers.

94. A method of selling items over a computer network, comprising:

(a) over a computer network, offering a first item for sale by a seller to a first customer, such that the first customer purchases the first item from the seller during a first time period;

(b) during over the network and throughout a second time period after the first period, offering for sale by the seller to the first customer a second item;

(c) throughout the second period, preventing persons other than the first customer from purchasing the second item over the network; and

(d) over the network and during a third time period after the second period, offering for sale by the seller to a second plurality of customers, different from the first plurality of customers, all of the second plurality of items, if any, that were not sold to the first plurality of customers.

95. A method of selling items over a computer network, comprising:

(a) over a computer network, offering a first plurality of items for sale by a seller to a first plurality of customers, such that each of the first plurality of customers purchases at least one of the first plurality of items from the seller during a first time period;

(b) over the network and throughout a second time period after the first period, offering for sale by the seller to the first plurality of customers a second plurality of items;

(c) during the second period, preventing persons other than the first plurality of customers from purchasing any of the second plurality of items over the network; and

(d) over the network and during a third time period after the second period, offering for sale by the seller to a second plurality of customers, different from the first plurality of customers, all of the second plurality of items, if any, that were not sold to the first plurality of customers.

96. A method of selling items over a computer network, comprising:

(a) over a computer network, offering for sale, by a seller, a first set of one or more items to a first set of one or more customers, such that each of the first set of customers purchases at least one of the first set of items from the seller during a first time period;

(b) over the network and throughout a second time period after the first period, offering for sale, by the seller, to the first set of customers an index set of one or more items;

(c) during the second period, preventing persons other than the first set of customers from purchasing any of the index set of items over the network; and

(d) over the network and during a third time period after the second period, offering for sale, by the seller, to a second set of one or more customers, different from the first set of customers, any of the index set of items that was not sold to the first set of customers.

97. A method of selling, comprising:

(a) selling a first plurality of items to a first plurality of customers at a first network area, such that each of the first plurality of customers purchases an item of the first plurality;

(b) after (a), offering a second plurality of items for sale at a second network area to the first plurality of customers;

(c) permitting the first plurality of customers to purchase items of the second plurality of items at the second network area;

(d) preventing persons other than the first plurality of customers from purchasing any of the second plurality of items at the second network area;

(e) during (d) and after at least one item of the second plurality is purchased by at least one of the first plurality of customers, offering other of the items of the second plurality for sale at the first network area to a second plurality of customers.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this description, illustrate aspects of the subject technology and, together with the specification, serve to explain principles of the subject technology.

FIG. 1 is an exemplary diagram of a network in which systems and methods herein may be implemented.

FIG. 2 is an exemplary diagram of a client or server of FIG. 1.

FIG. 3 is an exemplary diagram of modules implementing methods of the subject technology.

FIG. 4 is a flowchart of exemplary processing according to some methods and systems of the subject technology.

### DETAILED DESCRIPTION

In the following detailed description, specific details are set forth to provide an understanding of the subject technology. It will be apparent, however, to one ordinarily skilled in the art that the subject technology may be practiced without some of these specific details. In other instances, well-known structures and techniques have not been shown in detail so as not to obscure the subject technology.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as “an aspect” may refer to one or more aspects and vice versa. A phrase such as “an embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such “an embodiment” may refer to one or more embodiments and vice versa. A phrase such as “a configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as “a configuration” may refer to one or more configurations and vice versa.

A so-called Request-for-Proposal (RFP) systems allow buyers to place bids, which sellers can then choose to satisfy. These systems can allow sellers to provide the same goods to buyers who value them differently and thereby improve their profit levels. And although at least one system warns users against bids that are too low, such systems can be daunting to some buyers because they must thoroughly understand the value and demand for the item, or risk submitting bids that are too high.

Falling-price systems drop the price of goods over time until they are sold. Buyers can commit to buy early, or wait for a lower price at the risk of losing the item. At least one such system allows a user to pay a premium to place firm bids for later days using a so-called buyer's agent. Like RFP systems, falling-price systems can allow sellers to provide the same goods to buyers who value them differently. But they can also be daunting to some buyers, who must thoroughly understand the value and demand for the item, or risk submitting bids that are too high.

The network-based sales mechanisms described so far are by no means the only ones currently available to buyers and sellers. Others include Dutch auctions, sealed bid auctions, and classifieds. But no single one of all of these different mechanisms appears to present an optimum solution for selling larger lots of goods, such as seasonal retail items, overstock, or discontinued merchandise.

As used herein, to “acquire” has a broad meaning and includes means, for example, to buy, borrow, lease, and/or rent. As used herein, to “possess” has a broad meaning and includes, for example, own and/or license and/or lease, and/or rent. As used herein, a “nonmonetary aspiration” has a broad meaning and includes, for example, a goal and/or desire and/or want.

As used herein, “rent” has a broad meaning and includes having temporary possession, including, for example, borrowing and/or leasing and/or renting, whether involving a transaction for consideration or not.

As used herein, a “post” by a user can be either a verb, meaning, for example, the act of posting, or inputting or entering, information into a user field or page, such as a web document; or a noun, meaning a posting, i.e., the information so inputted, or posted, by the user. Posting can also imply that the information entered by the user has been accepted and/or published and/or displayed by the network interface or web document with which the user is interacting.

As used herein, “skill” has a broad meaning, including, for example, talent, education, career, job, hobby, proficiency, preoccupation, and interest.

As used herein, “characteristic” of a user or other person has a broad meaning, including, for example, habit, style, quality, trait, personality, idiosyncrasy, or quirk.

As used herein, a “page region,” as in “user page region” or “group page region,” means part or all of one web page, or part or all of multiple web pages.

As used herein, a “web page” means a displayable page or set of information, such as may be coded by HTML, XML, or other computer network language, viewable by persons, generally via a graphical user interface, or by machines, at a network node. The network may be private or public, and may be the internet, and possibly, though not necessarily, the world wide web.

As used herein, “displaying” means actually presenting information via a display device, or providing information to a device, network, or computer system configured for display, the information capable of being represented in a display.

According to some aspects of the disclosure, a search system may include a search engine and a category suggestion engine. The search engine may receive a search query associated with, for example, a geographic area, and identify a group of documents that are associated with locations in the geographic area based on the search query. The category suggestion engine may identify categories associated with documents in the group of documents, score the categories, and present one or more highest-scoring ones of the categories as one or more category suggestions.

Some aspects of the disclosure relate generally to improved techniques for analyzing large directed graphs for use in computer systems, and to reducing the computational complexity of assigning ranks to nodes. Some embodiments include iteratively solving a ranking function for a set of document rank values with respect to a set of linked documents until a first stability condition is satisfied. The ranking function is modified so as to reduce the ranking function's computation cost and then the modified ranking function is solved until a second stability condition is satisfied.

Determining an existence of an association between two or more things, such as between two search queries, or between a search query and a document, refers to determining at least whether such an association exists, and possibly, although not necessarily, determining more attributes or information concerning the association.

In an attempt to increase the relevancy and quality of the web pages returned to the user, a search engine may attempt to sort the list of hits so that the most relevant and/or highest quality pages are at the top of the list of hits returned to the user. For example, the search engine may assign a rank or score to each hit, where the score is designed to correspond to the relevance or importance of the web page. Determining appropriate scores can be a difficult task. The importance of a web page to the user is inherently subjective and depends on the user's interests, knowledge, and attitudes. There is, however, much that can be determined objectively about the relative importance of a web page. Conventional methods of determining relevance are based on the contents of the web page. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. In other words, the Brin and Page algorithm attempts to quantify the importance of a web page based on more than just the content of the web page.

See the Summary section of this document for a description of implementations of the subject technology.

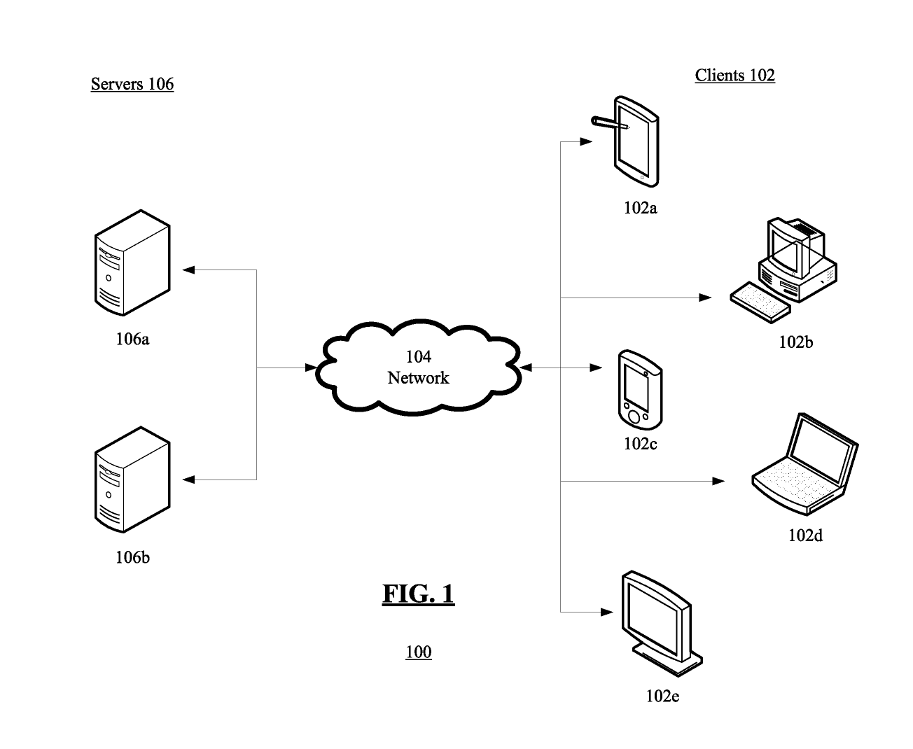

FIG. 1 is a simplified diagram of a system 100, in accordance with various embodiments of the subject technology. The system 100 may include one or more remote client devices 102 (e.g., client devices 102a, 102b, 102c, 102d, and 102e) in communication with one or more server computing devices 106 (e.g., servers 106a and 106b) via network 104. In some embodiments, a client device 102 is configured to run one or more applications based on communications with a server 106 over a network 104. In some embodiments, a server 106 is configured to run one or more applications based on communications with a client device 102 over the network 104. In some embodiments, a server 106 is configured to run one or more applications that may be accessed and controlled at a client device 102. For example, a user at a client device 102 may use a web browser to access and control an application running on a server 106 over the network 104. In some embodiments, a server 106 is configured to allow remote sessions (e.g., remote desktop sessions) wherein users can access applications and files on a server 106 by logging onto a server 106 from a client device 102. Such a connection may be established using any of several well-known techniques such as the Remote Desktop Protocol (RDP) on a Windows-based server.

By way of illustration and not limitation, in some embodiments, stated from a perspective of a server side (treating a server as a local device and treating a client device as a remote device), a server application is executed (or runs) at a server 106. While a remote client device 102 may receive and display a view of the server application on a display local to the remote client device 102, the remote client device 102 does not execute (or run) the server application at the remote client device 102. Stated in another way from a perspective of the client side (treating a server as remote device and treating a client device as a local device), a remote application is executed (or runs) at a remote server 106.

By way of illustration and not limitation, in some embodiments, a client device 102 can represent a desktop computer, a mobile phone, a laptop computer, a netbook computer, a tablet, a thin client device, a personal digital assistant (PDA), a portable computing device, and/or a suitable device with a processor. In one example, a client device 102 is a smartphone (e.g., iPhone, Android phone, Blackberry, etc.). In certain configurations, a client device 102 can represent an audio player, a game console, a camera, a camcorder, a Global Positioning System (GPS) receiver, a television set top box an audio device, a video device, a multimedia device, and/or a device capable of supporting a connection to a remote server. In some embodiments, a client device 102 can be mobile. In some embodiments, a client device 102 can be stationary. According to certain embodiments, a client device 102 may be a device having at least a processor and memory, where the total amount of memory of the client device 102 could be less than the total amount of memory in a server 106. In some embodiments, a client device 102 does not have a hard disk. In some embodiments, a client device 102 has a display smaller than a display supported by a server 106. In some aspects, a client device 102 may include one or more client devices.

In some embodiments, a server 106 may represent a computer, a laptop computer, a computing device, a virtual machine (e.g., VMware® Virtual Machine), a desktop session (e.g., Microsoft Terminal Server), a published application (e.g., Microsoft Terminal Server), and/or a suitable device with a processor. In some embodiments, a server 106 can be stationary. In some embodiments, a server 106 can be mobile. In certain configurations, a server 106 may be any device that can represent a client device. In some embodiments, a server 106 may include one or more servers.

In some embodiments, a first device is remote to a second device when the first device is not directly connected to the second device. In some embodiments, a first remote device may be connected to a second device over a communication network such as a Local Area Network (LAN), a Wide Area Network (WAN), and/or other network.

When a client device 102 and a server 106 are remote with respect to each other, a client device 102 may connect to a server 106 over the network 104, for example, via a modem connection, a LAN connection including the Ethernet or a broadband WAN connection including DSL, Cable, T1, T3, Fiber Optics, Wi-Fi, and/or a mobile network connection including GSM, GPRS, 3G, 4G, 4G LTE, WiMax or other network connection. Network 104 can be a LAN network, a WAN network, a wireless network, the Internet, an intranet, and/or other network. The network 104 may include one or more routers for routing data between client devices and/or servers. A remote device (e.g., client device, server) on a network may be addressed by a corresponding network address, such as, but not limited to, an Internet protocol (IP) address, an Internet name, a Windows Internet name service (WINS) name, a domain name, and/or other system name. These illustrate some examples as to how one device may be remote to another device, but the subject technology is not limited to these examples.

According to certain embodiments of the subject technology, the terms “server” and “remote server” are generally used synonymously in relation to a client device, and the word “remote” may indicate that a server is in communication with other device(s), for example, over a network connection(s).

According to certain embodiments of the subject technology, the terms “client device” and “remote client device” are generally used synonymously in relation to a server, and the word “remote” may indicate that a client device is in communication with a server(s), for example, over a network connection(s).

In some embodiments, a “client device” may be sometimes referred to as a client or vice versa. Similarly, a “server” may be sometimes referred to as a server device or vice versa.

In some embodiments, the terms “local” and “remote” are relative terms, and a client device may be referred to as a local client device or a remote client device, depending on whether a client device is described from a client side or from a server side, respectively. Similarly, a server may be referred to as a local server or a remote server, depending on whether a server is described from a server side or from a client side, respectively. Furthermore, an application running on a server may be referred to as a local application, if described from a server side, and may be referred to as a remote application, if described from a client side.

In some embodiments, devices placed on a client side (e.g., devices connected directly to a client device(s) or to one another using wires or wirelessly) may be referred to as local devices with respect to a client device and remote devices with respect to a server. Similarly, devices placed on a server side (e.g., devices connected directly to a server(s) or to one another using wires or wirelessly) may be referred to as local devices with respect to a server and remote devices with respect to a client device.

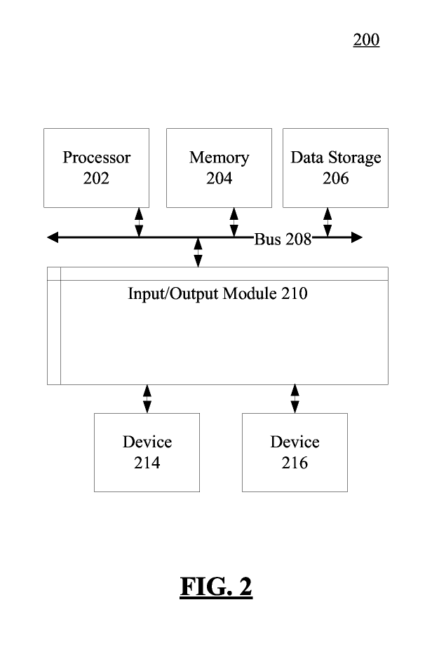

FIG. 2 is a block diagram illustrating an exemplary computer system 200 with which a client device 102 and/or a server 106 of FIG. 1 can be implemented. In certain embodiments, the computer system 200 may be implemented using hardware or a combination of software and hardware, either in a dedicated server, or integrated into another entity, or distributed across multiple entities.

The computer system 200 (e.g., client 102 and servers 106) includes a bus 208 or other communication mechanism for communicating information, and a processor 202 coupled with the bus 208 for processing information. By way of example, the computer system 200 may be implemented with one or more processors 202. The processor 202 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, and/or any other suitable entity that can perform calculations or other manipulations of information.

The computer system 200 can include, in addition to hardware, code that creates an execution environment for the computer program in question, e.g., code that constitutes processor firmware, a protocol stack, a database management system, an operating system, or a combination of one or more of them stored in an included memory 204, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, and/or any other suitable storage device, coupled to the bus 208 for storing information and instructions to be executed by the processor 202. The processor 202 and the memory 204 can be supplemented by, or incorporated in, special purpose logic circuitry.

The instructions may be stored in the memory 204 and implemented in one or more computer program products, i.e., one or more modules of computer program instructions encoded on a computer readable medium for execution by, or to control the operation of, the computer system 200, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and/or application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and/or xml-based languages. The memory 204 may also be used for storing temporary variable or other intermediate information during execution of instructions to be executed by the processor 202.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Some aspects of the invention include obtaining, modifying, storing, tracking, and/or displaying a customer's score based on the customer's purchasing behavior, such as loyalty to a seller or other factors. In some embodiments, a respective first price of an item of the index set of items (a) differs, as offered by the seller and displayed at the network, among customers of the first set of customers, and (b) is based on a respective score determined by a processor and associated with each of at least one customer of the first set of customers.

Customer scores may be determined by any method known to those of skill in the art, such as weighting functions, by which one or more factors may be weighted more heavily than other factors, and the presence, absence, and/or degree or magnitude of a factor in any instance may be assigned one or more numerical values or other indications implementable in code.

Exemplary factors used for calculating customer scores may include (a) a number of items purchased by the respective customer from the seller; (b) a frequency of purchases made by the respective customer from the seller; (c) an amount paid for one or more purchases by the respective customer; (d) whether the respective customer returned an item sold by the seller; (e) whether a return to the seller of an item was determined by the seller to have been made in good faith by the respective customer; (f) whether the respective customer was determined to have engaged in a fraudulent transaction; (g) whether the respective customer recommended, over a computer network, to another entity an item offered for sale by the seller;

(h) whether the respective customer provided, over the network, feedback regarding an item offered for sale by the seller; and/or (i) other indicators of customer behavior.

The computer system 200 further includes a data storage device 206 such as a magnetic disk or optical disk, coupled to the bus 208 for storing information and instructions. The computer system 200 may be coupled via an input/output module 210 to various devices (e.g., devices 214 and 216). The input/output module 210 can be any input/output module. Exemplary input/output modules 210 include data ports (e.g., USB ports), audio ports, and/or video ports. In some embodiments, the input/output module 210 includes a communications module. Exemplary communications modules include networking interface cards, such as Ethernet cards, modems, and routers. In certain aspects, the input/output module 210 is configured to connect to a plurality of devices, such as an input device 214 and/or an output device 216. Exemplary input devices 214 include a keyboard and/or a pointing device (e.g., a mouse or a trackball) by which a user can provide input to the computer system 200. Other kinds of input devices 214 can be used to provide for interaction with a user as well, such as a tactile input device, visual input device, audio input device, and/or brain-computer interface device. For example, feedback provided to the user can be any form of sensory feedback (e.g., visual feedback, auditory feedback, and/or tactile feedback), and input from the user can be received in any form, including acoustic, speech, tactile, and/or brain wave input. Exemplary output devices 216 include display devices, such as a cathode ray tube (CRT) or liquid crystal display (LCD) monitor, for displaying information to the user.

According to certain embodiments, a client device 102 and/or server 106 can be implemented using the computer system 200 in response to the processor 202 executing one or more sequences of one or more instructions contained in the memory 204. Such instructions may be read into the memory 204 from another machine-readable medium, such as the data storage device 206. Execution of the sequences of instructions contained in the memory 204 causes the processor 202 to perform the process steps described herein. One or more processors in a multi-processing arrangement may also be employed to execute the sequences of instructions contained in the memory 204. In some embodiments, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component (e.g., a data server), or that includes a middleware component (e.g., an application server), or that includes a front end component (e.g., a client computer having a graphical user interface and/or a Web browser through which a user can interact with an implementation of the subject matter described in this specification), or any combination of one or more such back end, middleware, or front end components. The components of the system 200 can be interconnected by any form or medium of digital data communication (e.g., a communication network). Examples of communication networks include a local area network and a wide area network.

The term “machine-readable storage medium” or “computer readable medium” as used herein refers to any medium or media that participates in providing instructions to the processor 202 for execution. Such a medium may take many forms, including, but not limited to, non-volatile media, volatile media, and transmission media. Non-volatile media include, for example, optical or magnetic disks, such as the data storage device 206. Volatile media include dynamic memory, such as the memory 204. Transmission media include coaxial cables, copper wire, and fiber optics, including the wires that comprise the bus 208. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, a “processor” can include one or more processors, and a “module” can include one or more modules.

In an aspect of the subject technology, a machine-readable medium is a computer-readable medium encoded or stored with instructions and is a computing element, which defines structural and functional relationships between the instructions and the rest of the system, which permit the instructions' functionality to be realized. Instructions may be executable, for example, by a system or by a processor of the system. Instructions can be, for example, a computer program including code. A machine-readable medium may comprise one or more media.

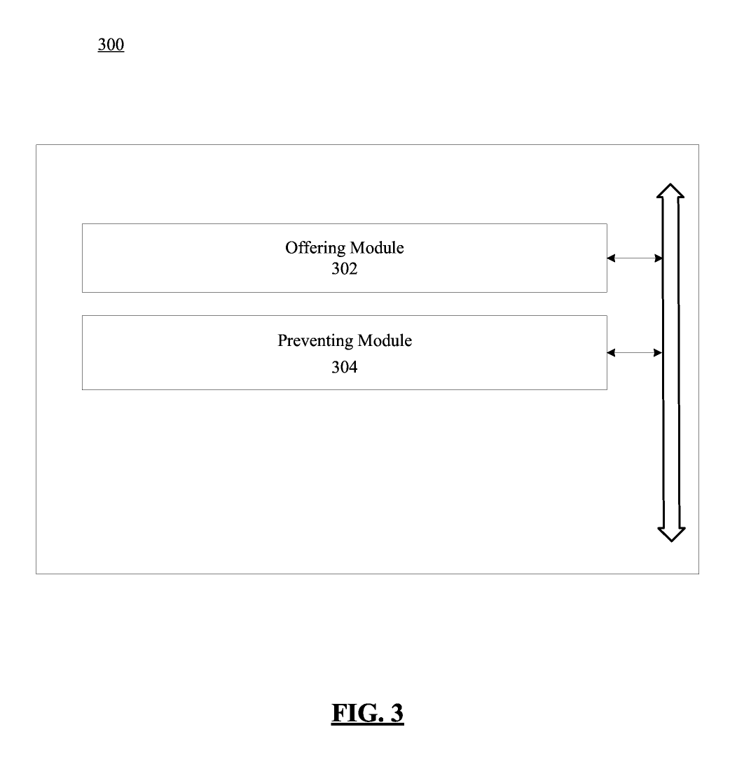

FIG. 3 illustrates an example of a system 300 for selling items in accordance with various embodiments of the subject technology. The system 300 is an example of an implementation of a client device 102 and/or a server 106 for selling items and providing selective access by customers to purchase such items. The system 300 comprises offering module 302 and preventing module 304. Although the system 300 is shown as having these modules, the system 300 may have other suitable configurations. The modules of the system 300 may be in communication with one another. In some embodiments, the modules may be implemented in software (e.g., subroutines and code). For example, the modules may be stored in the memory 204 and/or data storage 206, and executed by the processor 202. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

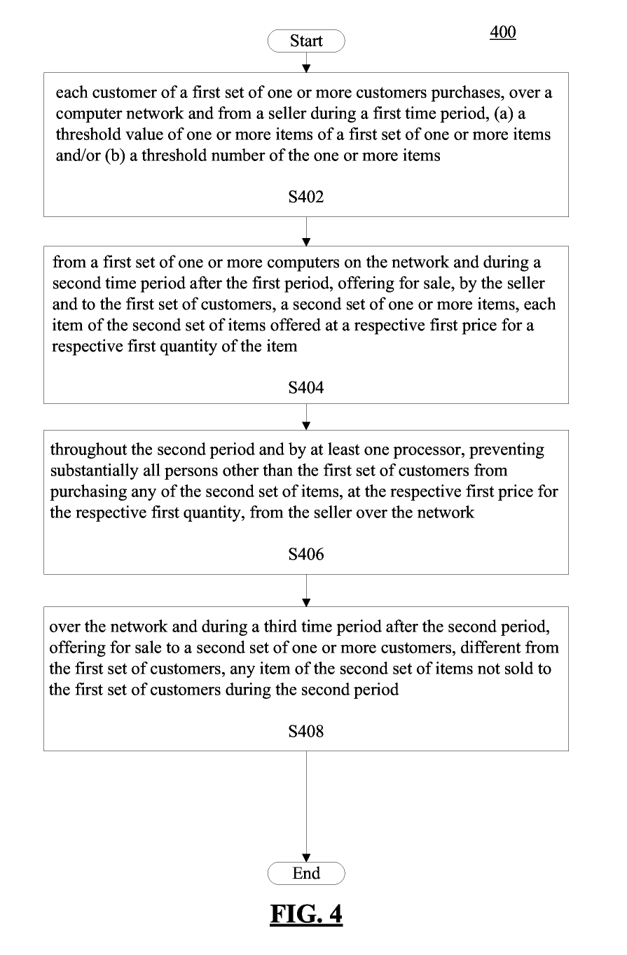

FIG. 4 illustrates an example of a method, or steps performed by a module or machine-readable medium, for selling items over a computer network according to principles of the subject technology. In step S402, each customer of a first set of one or more customers purchases, over a computer network and from a seller during a first time period, (a) a threshold value of one or more items of a first set of one or more items and/or (b) a threshold number of the one or more items.

Step S404 includes, from a first set of one or more computers on the network and during a second time period after the first period, offering for sale, by the seller and to the first set of customers, an index set of one or more items, each item of the index set of items offered at a respective first price for a respective first quantity of the item.

Step S406 includes, throughout the second period and by at least one processor, preventing substantially all persons other than the first set of customers from purchasing any of the index set of items, at the respective first price for the respective first quantity, from the seller over the network.

Step 408 includes, over the network and during a third time period after the second period, offering for sale to a second set of one or more customers, different from the first set of customers, any item of the index set of items not sold to the first set of customers during the second period.

Some embodiments of the subject technology include a method of selling items over a computer network, comprising: after each customer of a first set of one or more customers has been selected by a set of one or more sellers during a first time period; from a first set of one or more computers at the network and during a second time period after the first period, offering for sale, by the set of sellers and to the first set of customers, an index set of one or more items, each item of the index set of items offered at a respective first price for a respective first quantity of the item; throughout the second period and by at least one processor, preventing substantially all persons other than the first set of customers from purchasing any of the index set of items, at the respective first price for the respective first quantity, from the set of sellers over the network; and over the network and during a third time period after the second period, offering for sale to a second set of one or more customers, different from the first set of customers, any item of the index set of items not sold to the first set of customers during the second period.

In some embodiments, the first set of customers has been selected by the set of sellers, during the first period, based on at least one of (a) a threshold value of one or more items of a first set of one or more items purchased by the first set of customers from the set of sellers, or (b) a threshold number of the one or more items of the first set of items, wherein the threshold value and the threshold number are each greater than zero.

As used herein, any action, such as offering, selling, or buying, by a “set of one or more sellers,” a “set of sellers,” a “set of one or more customers,” or a “set of customers,” may be executed by any one or more of the one or more sellers in the set of sellers or any one or more of the one or more customers in the set of customers. Thus, “offering for sale, by a set of sellers and to a set of customers, a set of one or more items” can include any combination of one or more sellers in the set of one or more sellers, each offering any combination of one or more items to each or any combination of one or more customers.

According to certain embodiments of the subject technology, the terms “server” and “remote server” are generally used synonymously in relation to a client device, and the word “remote” may indicate that a server is in communication with other device(s), for example, over a network connection(s).

According to certain embodiments of the subject technology, the terms “client device” and “remote client device” are generally used synonymously in relation to a server, and the word “remote” may indicate that a client device is in communication with a server(s), for example, over a network connection(s).

In some embodiments, a “client device” may be sometimes referred to as a client or vice versa. Similarly, a “server” may be sometimes referred to as a server device or server computer or like terms.

In some embodiments, the terms “local” and “remote” are relative terms, and a client device may be referred to as a local client device or a remote client device, depending on whether a client device is described from a client side or from a server side, respectively. Similarly, a server may be referred to as a local server or a remote server, depending on whether a server is described from a server side or from a client side, respectively. Furthermore, an application running on a server may be referred to as a local application, if described from a server side, and may be referred to as a remote application, if described from a client side.

In some embodiments, devices placed on a client side (e.g., devices connected directly to a client device(s) or to one another using wires or wirelessly) may be referred to as local devices with respect to a client device and remote devices with respect to a server. Similarly, devices placed on a server side (e.g., devices connected directly to a server(s) or to one another using wires or wirelessly) may be referred to as local devices with respect to a server and remote devices with respect to a client device.

As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

One or more system components, such as processors, can prevent substantially all persons (and/or machines, such as computers) other than the first set of customers (and/or computers controlled by those customers) from purchasing any of the index set of items from the seller over the network via the first computer. This can be done by any method known to those skilled in the art, such as by the use of password protection with or without use of cookies, use of public and/or private encryption keys; or blocking of access based on IP addresses, IP subnets, usernames, passwords, geolocation information, local region, and/or other methods.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

As used herein, “selling” is a broad term that encompasses its ordinary meaning and can refer to many other transactions and transaction types, including, for example, auctioning, loaning, lending, renting, leasing, insuring, indemnifying, subrogating, trading, bartering, giving, and donating.

As used herein, “offering for sale” is a broad term that encompasses its ordinary meaning and can refer to offering to perform many other transactions and transaction types, including, for example, auctioning, loaning, lending, renting, leasing, insuring, indemnifying, subrogating, trading, bartering, giving, and donating. As used herein, “items” exchanged in transactions (e.g., sold, offered, or bought) can be goods or services, or promises or obligations to transact for (e.g., provide, offer, or buy) such goods or services.

As used herein, “buying” and “purchasing” are broad terms that encompass their ordinary meanings and can refer to many other transactions and transaction types, including, for example, bidding, paying, loaning, repaying, financing, refinancing, renting, leasing, trading, bartering, and receiving.

As used herein, “customer,” “buyer,” and “purchaser” are broad terms that encompass their ordinary meanings and can refer to one or more persons or organizations, or one or more agents (human, machine, or organizational) or affiliates of those persons or organizations, that engage, or potentially engage, or who may and/or will in the future engage, in any of various acts including, without limitation, buying, purchasing, bidding, paying, loaning, repaying, financing, refinancing, renting, leasing, trading, bartering, and receiving. Thus, for example, potential customers, buyers, or purchasers, or agents of any of those entities, who have not yet purchased any particular item, or who may not eventually purchase the item, can be included in the definition of “customers,” “buyers,” and “purchasers,” respectively.

As used herein, “seller” and “merchant” are broad terms that encompass their ordinary meanings and can refer to one or more persons or organizations, or one or more agents (human, machine, or organizational) or affiliates of those persons or organizations, that engage, or potentially engage, or who may and/or will in the future engage, in any of various acts including, without limitation, selling, auctioning, loaning, lending, renting, leasing, insuring, indemnifying, subrogating, trading, bartering, giving, and donating. Thus, for example, potential sellers or merchants, or agents or affiliates of those potential sellers or merchants, who have not yet sold any particular item, or who do not eventually sell the item, can be included in the definition of “sellers” or “merchants.”

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While certain aspects and embodiments of the invention have been described, these have been presented by way of example only, and are not intended to limit the scope of the invention. Indeed, the novel methods and systems described herein may be embodied in a variety of other forms without departing from the spirit thereof. The accompanying claims and their equivalents are intended to cover such forms or modifications as would fall within the scope and spirit of the invention.

What is claimed is:

1. A method of selling items over a computer network, comprising:
after each customer of a first set of one or more customers has been selected by a set of one or more sellers during a first time period;
from a first set of one or more computers at a network and during a second time period after the first period, offering for sale, by the set of sellers and to the first set of customers, an index set of one or more items, each item of the index set of items offered at a respective first price for a respective first quantity of the item;
throughout the second period and by at least one processor, preventing substantially all persons other than the first set of customers from purchasing any of the index set of items, at the respective first price for the respective first quantity, from the set of sellers over the network; and
over the network and during a third time period after the second period, offering for sale to a second set of one or more customers, different from the first set of customers, any item of the index set of items not sold to the first set of customers during the second period.

2. The method of claim 1, wherein the first set of customers has been selected by the set of sellers, during the first period, based on at least one of (a) a threshold value of one or more items of a first set of one or more items purchased by the first set of customers from the set of sellers, or (b) a threshold number of the one or more items of the first set of items, wherein the threshold value and the threshold number are each greater than zero.

3. The method of claim 1, further comprising, throughout the second period, preventing substantially all persons other than the first set of customers from purchasing any of the index set of items from the set of sellers over the network.

4. The method of claim 1, further comprising, throughout the second period, preventing substantially all persons other than the first set of customers from purchasing any of the index set of items from any seller over the network.

5. The method of claim 1, wherein the at least one of the threshold value or the threshold number is determined by the set of sellers.

6. The method of claim 1, wherein the second set of customers comprises the public.

7. The method of claim 1, wherein the second set of customers includes the first set of customers.

8. The method of claim 1, wherein the first set of computers comprises a server computer, and each customer of the first set of customers has purchased the one or more items of the first set of items, during the first period, at a respective remote computer in the network.

9. The method of claim 1, wherein the second period comprises at least one day.

10. The method of claim 1, wherein the computer network comprises the Internet.

11. The method of claim 1, further comprising, after at least one item of the index set of items has been purchased during the third period by at least one of the second set of customers, preventing substantially all of the first set of customers from purchasing, during the third period, the at least one item of the index set of items.

12. The method of claim 1, further comprising, throughout the second period, preventing all persons other than the first set of customers from purchasing any of the index set of items over the network.

13. The method of claim 1, further comprising, during the third period, offering for sale to the second set of customers all items of the index set of items not sold to the first set of customers.

14. The method of claim 1, further comprising, during the third period, offering for sale, at substantially the respective first price for the respective first quantity, to the first set of customers the any item of the index set of items not sold to the first set of customers during the second period.

15. The method of claim 1, wherein:
during the third period, each item of the any of the index set of items not sold to the first set of customers is offered for sale, by the set of sellers and to the second set of customers, at a respective second price for a respective second quantity of the item;
wherein, for each item of the any of the index set of items, the multiplication product of the respective first price and the respective first quantity is less than the multiplication product of the respective second price and the respective second quantity.

16. The method of claim 1, wherein the respective first price of a first item of the index set of items (a) differs, as offered by the set of sellers, among customers of the first set of customers, and (b) is based on a respective score determined by a processor and associated with each of at least one customer of the first set of customers.

17. The method of claim 1, wherein the respective first price of a first item, of the index set of items, offered during the second period by a first seller of the set of sellers, to a first customer of the first set of customers, is lower in (a) the event the selection of the first customer during the first period is by the first seller, than in (b) the event the selection of the first customer during the first period is by a second seller of the set of sellers.

18. The method of claim 17, wherein, upon occurrence of the event (b), the first seller pays a portion of the respective first price to the second seller.

19. The method of claim 16, wherein the score associated with a respective customer is displayed at the network to the respective customer;
wherein the score associated with a respective customer is based on one or more factors selected from the group of factors consisting of:
(a) a number of items purchased by the respective customer from the set of sellers;
(b) a frequency of purchases made by the respective customer from the set of sellers;
(c) an amount paid for one or more purchases by the respective customer;
(d) whether the respective customer returned an item sold by the set of sellers;
(e) whether a return to the set of sellers of an item was determined by the set of sellers to have been made in good faith by the respective customer;
(f) whether the respective customer was determined to have engaged in a fraudulent transaction;
(g) whether the respective customer recommended, over a computer network, to another entity an item offered for sale by the set of sellers; and
(h) whether the respective customer provided, over the network, feedback regarding an item offered for sale by the set of sellers.

20. A processor-based system for selling items over a computer network, comprising:
an offering module that (i) after confirmation is received by the system that each customer of a first set of one or more customers has purchased, over a computer network and from a seller during a first time period, at least one of (a) a threshold value of one or more items of a first set of one or more items, or (b) a threshold number of the one or more items, wherein the threshold value and the threshold number are each greater than zero, and (ii) from a first set of one or more computers at the network and during a second time period after the first period, offers for sale, by the seller and to the first set of customers, an index set of one or more items, each item of the index set of items offered at a respective first price for a respective first quantity of the item;
a preventing module that, throughout the second period and by at least one processor, prevents substantially all persons other than the first set of customers from purchasing any of the index set of items, at the respective first price for the respective first quantity, from the seller over the network; and
wherein the offering module, over the network and during a third time period after the second period, offers for sale to a second set of one or more customers, different from the first set of customers, any item of the index set of items not sold to the first set of customers during the second period.
